(19) United States
(12) Patent Application Publication
(10) Pub. No.: US 2006/0070534 A1
(43) Pub. Date: Apr. 6, 2006

(54) Tea bag press and holder

(76) Inventor: Thelma M. Payton, Clinton, IN (US)

Correspondence Address: BAKER & DANIELS LLP, 300 NORTH MERIDIAN STREET, SUITE 2700, INDIANAPOLIS, IN, 46204, US

(21) Appl. No.: 10/957,972

(22) Filed: Oct. 4, 2004

(51) Int. Cl. B30B 9/02

(52) U.S. Cl. 100/104

(57) ABSTRACT

The present invention provides an aesthetically pleasing tea press that hides a tea bag from view as the tea bag is being used to drain tea into a cup. The tea press includes a first section and a second section movably attached to the first section, thereby enabling the first and second sections to be closed together, wherein at least one of the first and second sections defines a tea draining aperture and has a tea bag accommodating area such that the first and second sections create a cavity suitably sized to hide a tea bag from view when the sections are closed together.

### TECHNICAL BACKGROUND

This invention generally relates to devices for handling a tea bag at the conclusion of the brewing process. More particularly, this invention relates to devices for use in an elegant setting.

### BACKGROUND OF THE INVENTION

Tea bags are widely used in both formal and informal settings, from fine dining establishments to fast food restaurants as well as in the home. Brewing tea requires the use of very hot or boiling water. The brewing process can last anywhere from a few seconds to approximately five (5) minutes to suit individual tastes. At the end of the brewing process, the tea bag is removed from the brewing container and is still exceedingly hot. Tea bag holders are used to hold the hot tea bags so that the tea drinker does not burn his hand on the hot tea bag.

Known devices exist for holding a tea bag after the brewing process and for squeezing the tea from the bag. Because a tea drinker is considered to have poor manners if he leaves the bag in the cup while consuming the tea, the tea drinker should dispose of the tea bag in a practical and aesthetically pleasing manner prior to drinking the tea. There are no known devices, however, which efficiently, and in an aesthetically pleasing manner, squeeze the final essence of flavor from the tea bag into a cup and also completely hides the unsightly, soggy tea bag from view during the tea bag draining process and afterward.

Examples of such prior art devices include tongs used to hold and press tea bags, as well as spoons and other types of holders and presses. Many of the known devices, however, primarily consist of metal or plastic, which are more appropriate for the kitchen, a buffet table or a very casual dining atmosphere than for a formal table setting. Secondly, while prior art tongs, spoons, squeezers, holders and pressers can effectively remove the bag from the liquid and squeeze out the remaining tea, the prior art devices do nothing to remove the unsightly tea bag from view.

### SUMMARY OF THE INVENTION

The present invention provides a tea holder and press which effectively hides the tea bag from view while a draining aperture in the press drains the tea from the tea bag. Furthermore, the inventive tea bag holder and press contains decorative designs that make the holder aesthetically pleasing to the human eye and suitable for use in an elegant and formal setting.

In one form of the present invention a tea bag holder is provided, the tea bag holder including a top section defining a top tea bag accommodating area; a bottom section defining a bottom tea-bag accommodating area, at least one of the top and bottom sections defining an aperture therein; and a connection member connecting the top and bottom sections and enabling the top and bottom sections to close together such that the top and bottom tea bag accommodating areas form a cavity suitably sized to hide the tea bag from view.

In another form of the present invention, a tea press includes a first section, and a second section movably attached to the first section, thereby enabling the first and second sections to be closed together, wherein at least one of the first and second sections defines a tea draining aperture and has a tea bag accommodating area such that the first and second sections create a cavity suitably sized to hide a tea bag from view when the sections are closed together.

In yet another form of the present invention, the tea press includes a top section having a top outer surface including a first design, and a bottom section movably attached to the top section, the bottom section having an inner bottom surface and an outer bottom surface, wherein the inner bottom surface includes a second design and the outer bottom surface includes a third design.

### DESCRIPTION OF THE DRAWINGS

The above-mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagrammatic view of the tea holder and press invention in a fully closed position;

FIG. 2 is an exploded diagrammatic view of the tea holder and press of the present invention in an open position;

FIG. 3 is an illustrative view of an embodiment of the tea holder and press invention having a religious symbol design on the outer bottom surface of the bottom section of the tea holder and press; and

FIG. 4 is a diagrammatic view of the tea holder and press invention in a closed position and draining tea from a tea bag.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiments disclosed below are not intended to be exhaustive or limit the invention to the precise forms disclosed in the following detailed description. Rather, the embodiments are chosen and described so that others skilled in the art may utilize their teachings.

The use of the term “religious symbol” hereinafter refers to any symbol that may be used to identify a product with a particular religious group or occasion. Such religious symbols include, but are not limited to, a dove, a cross, a fish, an anchor, a triangle, a circle, a peacock, a phoenix, a palm leaf and a lamp.

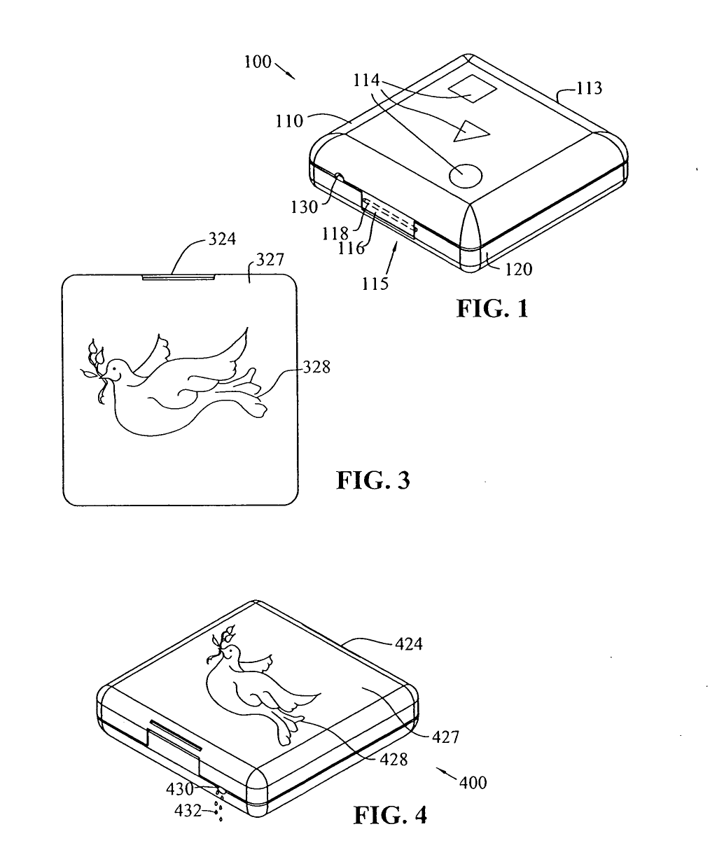

The tea holder and press (“tea press”) of the present invention is shown in FIG. 1. Tea press 100 includes top section 110 connected to bottom section 120 by hinge 115. Top section 110 has top outer surface 113, on which decorative designs 114 are displayed. In the embodiment of tea press 100 shown in FIG. 1, decorative designs 114 are represented as geometric shapes. It is contemplated, however, that any decorative design may be displayed on top outer surface 113 in place of geometric shapes 114, including, for example, religious symbol designs. Decorative designs 114 may be etched or painted into surface 113, or in other embodiments, made from a different material than top section 110 and attached thereto by the use of adhesives (e.g., decals and stickers).

Top section 110 of tea press 100 also defines aperture 130 in the backend of top section 110 to the left of hinge 115. Aperture 130 is used to drain a tea bag when tea press 100 is in its closed position. In other embodiments of the present invention, aperture 130 may be formed in bottom section 120 or in both top and bottom sections 110, 120.

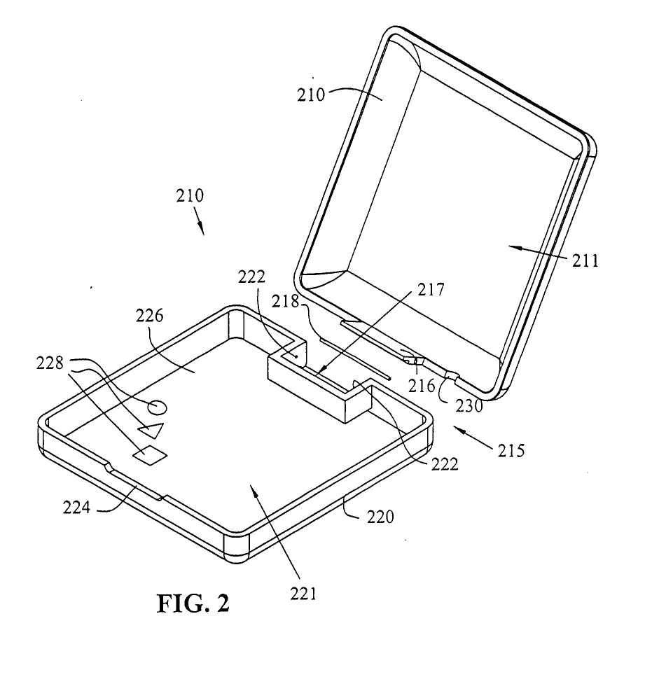

Bottom section 120 includes hinge 115. Hinge 115 includes hinge member 116 and hinge pin 118, which extends through hinge member 116 and into hinge pin receptacles located in bottom section 120 on each side of hinge pin 118. Hinge 115 enables top section 110 and bottom section 120 to open and close between an open position (as shown in FIG. 2) and the closed position depicted in FIG. 1. In other embodiments of the present invention, hinge 115 may include seams of flexible material (e.g., plastic or cardboard) that connect top and bottom sections 110, 120.

The tea press of the present invention is shown in greater detail and in an open position in FIG. 2. Top section 210 includes tea bag accommodating area 211, which is suitably sized to contain tea bags of varying sizes and dimensions. Similarly, bottom section 220 includes tea bag accommodating area 221, which is also suitably sized to contain tea bags of varying sizes and dimensions. When a tea bag is placed in tea press 200, and press 200 is closed, tea bag accommodating areas 211, 221 form a cavity that completely contains the tea bag. The cavity formed by tea bag accommodating areas 211, 221 is slightly smaller than the water-absorbed tea bag so that as press 200 is closed, press 200 squeezes the tea bag and gets out all of the tea bag's flavor. Tea press 200 also prevents the tea bag, which is unsightly after being squeezed, from being seen by others in a formal table setting before it can be disposed of.

Bottom section 220 also includes indentation 224. Indentation 224 is useful to assist one in gripping and opening top section 210 when top and bottom sections 210, 220 are closed together and tea press 200 is in a closed position. Bottom section 220 also has inner bottom surface 226, which includes decorative designs 228. While decorative designs 228 are shown in FIG. 2 to include the circle, triangle and square geometric shapes, such shapes are simply representative of any symbol or decorative design, including, but not limited to, religious symbols. Again, designs 228 may be etched or molded into inner bottom surface 226, painted on surface 226, or made from a different material than bottom section 220 and then attached to surface 226.

As described supra, the hinge includes hinge member 216 and hinge pin 218. Hinge pin 218 extends through hinge member 216 and is positioned in apertures 222 (one of which is not shown) in hinge receptacle 217 of bottom section 220. The top portion of the hinge member 216 does not permit top section 210 to fully open, allowing the user of tea press 200 to hold open press 200 in one hand while lifting a tea bag with the other hand. In other embodiments of the present invention, the hinge feature may be replaced with a seam of flexible material between top section 210 and bottom section 220 which enables top and bottom sections 210, 220 to alternate between an open and a closed position.

Now referring to FIG. 3, outer bottom surface 327 of the bottom section of the tea press is shown. Indentation 324 is formed in outer bottom surface 327, and as described supra, indentation 324 is useful in assisting the user of the tea press in opening the tea press from a closed to an open position. Bottom surface 327 also includes decorative design 328. In the embodiment of the tea press shown in FIG. 3, the decorative design is a religious symbol, i.e., a dove. It is contemplated that other religious symbols may be provided on outer bottom surface 327. Decorative design 328 may be etched or molded into outer bottom surface 327, painted on surface 327, or made of a different material from which the tea press is made and then attached to outer bottom surface 327 by use of an adhesive.

The function of the tea press is demonstrated in FIG. 4. A tea bag is removed from a cup of hot tea either by the string and tag or by lifting the tea bag with a spoon and placing it in the bottom section of tea press 400, which is then closed and turned with outer bottom surface 427 facing the user of tea press 400. The user then holds tea press 400 over a tea cup and slightly tilts tea press 400 to the right. Because the tea bag was being squeezed by press 400 as press 400 was closed, flavor 432 escapes through drainage aperture 430 into the tea cup. Tea flavor 432 is efficiently squeezed from the tea bag without burning the user's fingers, and the tea bag also remains hidden from view within decorative tea press 400 until the tea bag can be removed from the dining area. To increase the aesthetic quality of tea press 400 while it is being used, decorative design 328 on outer bottom surface 427 is viewable. The bottom section of tea press 400 section retains any residual liquid, thereby protecting the table cloth or other dining surface as well as the user from drips caused by seepage from the used tea bag.

In one embodiment of the inventive tea press, the tea press is made from a high quality porcelain, is square in shape, has outer dimensions of approximately 7.5 cm×7.5 cm×1.3 cm, and accommodates both common tea bags with strings and tags as well as square or round herbal tea bags with no strings or tags. In other embodiments of the present invention, it is contemplated that the tea press may be made of a lesser quality porcelain, tempered glass, ceramic, wood, plastic, metal or a specially treated cardboard product to make it disposable for restaurant use. The tea press may also be formed into other geometric shapes (e.g., oval, round, or rectangular) and sized to accommodate common tea bags and/or herbal tea bags of either one or multiple shapes and sizes.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A tea bag holder comprising:
a top section defining a top tea bag accommodating area;
a bottom section defining a bottom tea bag accommodating area, at least one of said top and bottom sections defining an aperture therein; and
a connecting member connecting said top and bottom sections and enabling the top and bottom sections to close together such that the top and bottom tea bag accommodating areas form a cavity suitably sized to hide a tea bag from view.

2. The tea bag holder of claim 1 wherein the aperture is positioned proximate to the connecting member.

3. The tea bag holder of claim 1 wherein said top section has a top outer surface including a decorative design.

4. The tea bag holder of claim 1 wherein said bottom section has an inner bottom surface including a decorative design.

5. The tea bag holder of claim 1 wherein said bottom section has an outer bottom surface including a decorative design.

6. The tea bag holder of claim 5 wherein the decorative design includes a religious symbol.

7. The tea bag holder of claim 6 wherein the religious symbol includes a dove.

8. A tea press comprising:
a first section; and
a second section movably attached to said first section, thereby enabling said first and second sections to be closed together, wherein at least one of said first and second sections defines a tea draining aperture and has a tea bag accommodating area such that said first and second sections create a cavity suitably sized to hide a tea bag from view when said sections are closed together.

9. The tea press of claim 8 further including a connecting member movably attaching said first and second sections and enabling said first and second sections to be closed together.

10. The tea press of claim 8 wherein said first section has a top outer surface including a decorative design.

11. The tea press of claim 8 wherein said second section has an inner bottom surface including a decorative design.

12. The tea press of claim 8 wherein said second section has an outer bottom surface including a decorative design.

13. The tea press of claim 12 wherein the decorative design includes a decorative religious symbol design.

14. The tea press of claim 9 wherein the first section has both a front end opposite the connecting member and a back end, the tea draining aperture positioned at the back end proximate to said hinge.

15. The tea press of claim 9 wherein said second section has a front end opposite said connecting member and defining an indentation that enables said first section to be gripped and opened when said first and second sections are closed together.

16. A tea press comprising:
a top section having a top outer surface including a first design; and
a bottom section movably attached to said top section, said bottom section having an inner bottom surface and an outer bottom surface, wherein the inner bottom surface includes a second design and the outer bottom surface includes a third design.

17. The tea press of claim 16 wherein the third design includes a decorative religious symbol design.

18. The tea press of claim 16 further comprising a hinge movably attaching said top and bottom sections and enabling said top and bottom sections to be closed together.

19. The tea press of claims 18 wherein at least one of said top and bottom sections includes a tea bag accommodating area such that said top and bottom sections create a cavity suitably sized to hide a tea bag from view when said sections are closed together.

20. The tea press of claim 18 wherein at least one of said top and bottom sections defines a tea draining aperture positioned proximate to said hinge.
